(19) United States
(12) Patent Application Publication
(10) Pub. No.: US 2026/0362357 A1
(43) Pub. Date: Nov. 12, 2026

(54) METHODS AND APPARATUSES FOR TA ACQUISITION

(71) Applicant: LENOVO (BEIJING) LIMITED, Beijing (CN)

(72) Inventors: Lianhai WU, Beijing (CN); Shuigen YANG, Shanghai (CN); Ran YUE, Beijing (CN); Haiming WANG, Beijing (CN)

(21) Appl. No.: 19/134,542

(22) PCT Filed: Jan. 12, 2023
(86) PCT No.: PCT/CN2023/071941

§ 371 Date: May 30, 2025

(51) Int. Cl. H04W 56/00; H04W 74/0833; H04W 88/08

(52) U.S. Cl. CPC H04W 56/0045; H04W 56/001; H04W 74/0833; H04W 88/085

(57) ABSTRACT

Embodiments of the present application relate to methods and apparatuses for timing advance (TA) acquisition under a 3rd Generation Partnership Project (3GPP) 5G system or the like. According to an embodiment of the present application, a candidate distributed unit (DU) of a base station (BS) includes a transceiver and a processor coupled to the transceiver, and the processor is configured to receive a signal for timing advance (TA) acquisition associated with a candidate cell via the transceiver from a user equipment (UE); transmit a TA value associated with the candidate cell via the transceiver to a source DU of the BS via a CU of the BS or to the UE via random access response (RAR) message; and one of the candidate DU, the CU, the source DU and the UE determines whether the TA value associated with the candidate cell is valid or not.

### TECHNICAL FIELD

Embodiments of the present application generally relate to wireless communication technology, especially to methods and apparatuses for timing advance (TA) acquisition.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g. time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding handling a TA value during or after TA acquisition have not been discussed in 3GPP 5G technology yet.

### SUMMARY

Some embodiments of the present application provide a candidate distributed unit (DU) of a base station (BS). The candidate DU includes a transceiver and a processor coupled to the transceiver; and the processor is configured to receive a signal for timing advance (TA) acquisition associated with a candidate cell via the transceiver from a user equipment (UE); transmit a TA value associated with the candidate cell via the transceiver to a source DU of the BS or the UE; and determine whether the TA value associated with the candidate cell is valid or not.

In some embodiments, the signal is at least one of: a preamble; or a sounding reference signal (SRS).

In some embodiments, the processor of the candidate DU is configured to calculate the TA value based on the received signal, and the TA value is transmitted to the source DU via a centralized unit (CU) of the BS.

In some embodiments, the processor of the candidate DU is configured to transmit at least one of the following to the source DU via the CU: identifier (ID) information of the candidate cell; or ID information of the UE.

In some embodiments, the TA value is transmitted to the UE in a random access response (RAR) message based on the received signal.

In some embodiments, whether the TA value is valid or not is determined based on a condition, wherein the condition based on which the TA value is to be determined as invalid includes at least one of the following: an expiry of an early TA timer; or a difference between a first reference signal received power (RSRP) value and a second RSRP value is greater than or equal to a threshold related to RSRP change.

In some embodiments, the processor of the candidate DU is configured to receive configuration information regarding the condition via the transceiver from the CU, and the configuration information includes at least one of the following: a value for the early TA timer; or the threshold related to RSRP change.

In some embodiments, the processor of the candidate DU is configured to start the early TA timer upon receiving the signal or upon calculating the TA value.

In some embodiments, the first RSRP value is a RSRP value when the candidate DU receives the signal or when the candidate DU calculates the TA value, and the second RSRP value is a RSRP value received from the CU or the source DU.

In some embodiments, the processor of the candidate DU is configured to receive, via the transceiver, at least one of the following: a Layer 1 (L1) measurement result of the UE from the source DU; or a Layer 3 (L3) measurement result of the UE from the CU, wherein the second RSRP value is included in at least one of the L1 measurement result or the L3 measurement result.

In some embodiments, in response to determining that the TA value is invalid, the processor of the candidate DU is configured to transmit information for indicating that the TA value is invalid via the transceiver to the source DU via the CU.

In some embodiments, the processor of the candidate DU is configured to transmit, via the transceiver to the source DU via the CU, configuration information regarding a random access channel (RACH) resource for TA acquisition associated with the candidate cell.

Some embodiments of the present application provide a centralized unit (CU) of a base station (BS). The CU includes a transceiver and a processor coupled to the transceiver; and the processor is configured to receive a timing advance (TA) value associated with a candidate cell via the transceiver from a candidate distributed unit (DU) of the BS; and transmit the TA value associated with the candidate cell via the transceiver to a source DU of the BS.

In some embodiments, the processor of the CU is configured to: receive identifier (ID) information of the candidate cell and ID information of a user equipment (UE) via the transceiver from the candidate DU; and transmit the ID information of the candidate cell and the ID information of the UE via the transceiver to the source DU.

In some embodiments, the processor of the CU is configured to determine whether the TA value associated with the candidate cell is valid or not.

In some embodiments, the processor of the CU is configured to determine that the TA value is invalid if a difference between a first reference signal received power (RSRP) value and a second RSRP value is greater than or equal to a threshold.

In some embodiments, the first RSRP value is a RSRP value when the CU receives the TA value, and the second RSRP value is a RSRP value received from the UE via the source DU.

In some embodiments, in response to determining that the TA value is invalid, the processor of the CU is configured to transmit, via the transceiver to the source DU, an indication for TA acquisition associated with the candidate cell.

In some embodiments, in response to determining that the TA value is invalid, the processor of the CU is configured to transmit, via the transceiver to the candidate DU, information for indicating that the TA value is invalid or a request for a random access channel (RACH) resource for TA acquisition associated with the candidate cell.

In some embodiments, the processor of the CU is configured to transmit, via the transceiver to at least one of the candidate DU or the source DU, configuration information regarding a condition associated with determining TA value validity.

In some embodiments, the configuration information includes at least one of the following: a value of an early TA timer; or a threshold related to RSRP change.

Some embodiments of the present application provide a source distributed unit (DU) of a base station (BS). The source DU includes a transceiver and a processor coupled to the transceiver; and the processor is configured to transmit a first indication for timing advance (TA) acquisition associated with a candidate cell via the transceiver to a user equipment (UE); and transmit a second indication for TA acquisition associated with the candidate cell via the transceiver to the UE.

In some embodiments, at least one of the first indication or the second indication is included in at least one of the following: downlink control information (DCI); a medium access control (MAC) control element (CE); or radio resource control (RRC) signaling.

In the embodiments, after transmitting the first indication, the processor of the source DU is configured to receive at least one of the following from the CU: a first TA value associated with the candidate cell; identifier (ID) information of the candidate cell; ID information of the UE; or configuration information regarding a condition used to determine whether the first TA value associated with the candidate cell is valid or not.

In the embodiments, the condition based on which the first TA value is to be determined as invalid includes at least one of the following: an expiry of an early TA timer; or a difference between a first reference signal received power (RSRP) value and a second RSRP value is greater than or equal to a threshold related to RSRP change.

In the embodiments, the configuration information regarding the condition includes at least one of the following: a value of the early TA timer; or the threshold related to RSRP change.

In the embodiments, the first RSRP value is a RSRP value when the source DU transmits the first indication or when the source DU receives the first TA value, and the second RSRP value is a RSRP value received from the UE.

In the embodiments, the processor of the source DU is configured to receive a Layer 1 (L1) measurement result of the UE via the transceiver from the UE, wherein the second RSRP value is included in the L1 measurement result.

In the embodiments, the processor of the source DU is configured to determine whether the first TA value associated with the candidate cell is valid or not based on the condition.

In the embodiments, the second indication is transmitted in response to determining that the first TA value is invalid.

In the embodiments, after transmitting the second indication, the processor of the source DU is configured to release configuration information regarding a random access channel (RACH) resource or a sounding reference signal (SRS) resource for acquiring the first TA value.

In the embodiments, the RACH resource includes at least one of the following: a preamble; or a time-frequency domain resource.

Some embodiments of the present application provide a user equipment (UE). The UE includes a transceiver and a processor coupled to the transceiver; and the processor is configured to receive a first indication for timing advance (TA) associated with a candidate cell via the transceiver from a source distributed unit (DU) of a base station (BS); transmit a first signal for TA acquisition via the transceiver to a candidate distributed unit (DU) of the BS based on the first indication; receive a second indication for TA acquisition associated with the candidate cell via the transceiver from the source DU; and transmit a second signal for TA acquisition via the transceiver to the candidate DU based on the second indication.

In the embodiments, at least one of the first indication or the second indication is included in at least one of the following: downlink control information (DCI); a medium access control (MAC) control element (CE); or radio resource control (RRC) signaling.

In the embodiments, at least one of the first signal or the second signal is at least one of: a preamble; or a sounding reference signal (SRS).

In the embodiments, the processor of the UE is configured to: receive a first TA value associated with the candidate cell via the transceiver from the candidate DU after transmitting the first signal; and determine whether the first TA value associated with the candidate cell is valid or not.

In the embodiments, the first TA value is included in: a cell switch command; or a random access response (RAR) message prior to the cell switch command.

In the embodiments, the processor of the UE is configured to determine that the first TA value is invalid based on a condition, and the condition includes at least one of the following: an expiry of an early TA timer; or a difference between a first reference signal received power (RSRP) value and a second RSRP value is greater than or equal to a threshold related to RSRP change.

In the embodiments, the processor of the UE is configured to receive configuration information regarding the condition via the transceiver from the CU, and the configuration information is configured by the CU or the candidate DU.

In the embodiments, the configuration information includes at least one of the following: a value of the early TA timer; or the threshold related to RSRP change.

In the embodiments, the processor of the UE is configured to start the early TA timer upon the UE receives the first indication or when the UE receives the first TA value.

In the embodiments, the first RSRP value is a RSRP value when the UE transmits the first signal, and the second RSRP value is a RSRP value measured by the UE after the UE receives the first TA value.

In the embodiments, the second signal is transmitted in response to determining that the first TA value is invalid.

In the embodiments, in response to determining that the first TA value is invalid, the processor of the UE is configured to transmit information for indicating that the first TA value is invalid via the transceiver to the source DU.

Some embodiments of the present application provide a method performed by a candidate distributed unit (DU) of a base station (BS). The method includes: receiving a signal for timing advance (TA) acquisition associated with a candidate cell from a user equipment (UE); transmitting a TA value associated with the candidate cell to a source DU of the BS or the UE; and determining whether the TA value associated with the candidate cell is valid or not.

Some embodiments of the present application provide a method performed by a centralized unit (CU) of a base station (BS). The method includes: receiving a timing advance (TA) value associated with a candidate cell from a candidate distributed unit (DU) of the BS; and transmitting the TA value associated with the candidate cell to a source DU of the BS.

Some embodiments of the present application provide a method performed by a source distributed unit (DU) of a base station (BS). The method includes: transmitting a first indication for timing advance (TA) acquisition associated with a candidate cell to a user equipment (UE); and transmitting a second indication for TA acquisition associated with the candidate cell to the UE

Some embodiments of the present application provide a method performed by a UE. The method includes: receiving a first indication for timing advance (TA) associated with a candidate cell from a source distributed unit (DU) of a base station (BS); transmitting a first signal for TA acquisition to a candidate distributed unit (DU) of the BS based on the first indication; receiving a second indication for TA acquisition associated with the candidate cell from the source DU; and transmitting a second signal for TA acquisition to the candidate DU based on the second indication.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g. a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present application.

FIG. 2 illustrates a schematic diagram of inter-cell Layer1/Layer2 (L1/L2) mobility in accordance with some embodiments of the present application.

FIGS. 3-6 illustrate exemplary flowcharts associated with TA acquisition in accordance with some embodiments of the present application.

FIGS. 7-10 illustrate exemplary flowcharts of TA acquisition in accordance with some embodiments of the present application.

FIG. 11 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

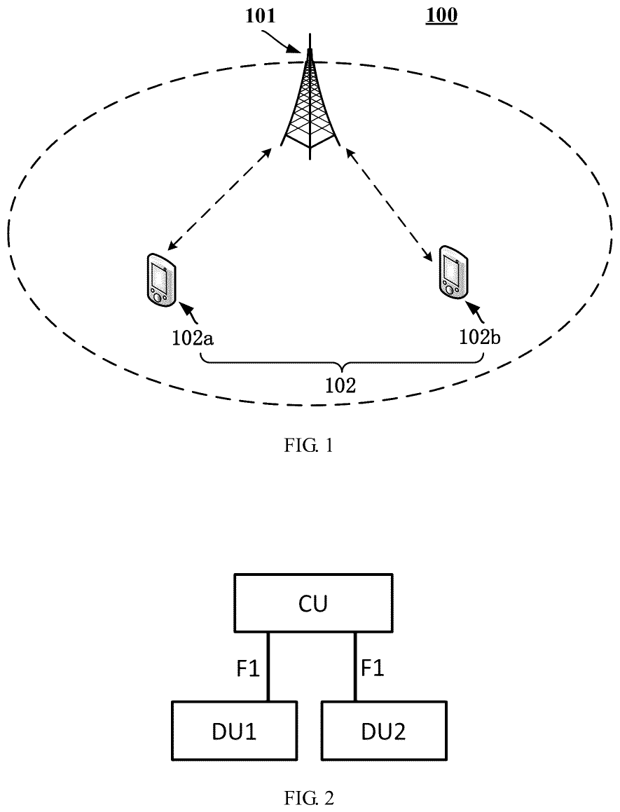

FIG. 1 illustrates a schematic diagram of a wireless communication system according to some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g. UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g. a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g. during a handover procedure for a UE.

UE 102, e.g. UE 102a and UE 102b, should be understood as any type terminal device, which may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g. gNB) may switch a UE to a new cell using L1/L2 signaling taking into account the received physical layer measurement result. In accordance with 3GPP standard documents, a BS may consist of a BS-centralized unit (CU) and one or more BS-distributed unit(s) (DU(s)). A BS-CU and a BS-DU are connected via an F1 interface which is a logical interface. One BS-DU is connected to only one BS-CU.

FIG. 2 illustrates a schematic diagram of inter-cell Layer1/Layer2 (L1/L2) mobility in accordance with some embodiments of the present application. As shown in FIG. 2, CU may communicate with two DUs, i.e., DU1 or DU2, via F1 interfaces. CU in FIG. 2 may implement legacy mobility decision based on Layer 3 (L3) measurement result. DU1 or DU2 in FIG. 2 may implement L1/L2 mobility decision based on physical layer measurement result(s).

Compared to legacy L3 mobility, L1/L2 mobility is considered faster with less processing delay and signaling delay. In legacy L3 mobility, a CU (e.g. CU as shown in FIG. 2) makes the mobility decision based on received radio resource management (RRM) measurement report. Different than legacy L3 mobility, in L1/L2 mobility, a DU (e.g. DU1 or DU2 as shown in FIG. 2) makes the mobility decision based on physical layer measurement result, e.g. carried in a channel state information (CSI) report. Besides, in legacy L3 mobility, the handover command is sent via RRC signaling from the SN CU to a UE, while in L1/L2 mobility, the “handover” command is sent via L1/L2 signaling (e.g. downlink control information (DCI) or a medium access control (MAC) control element (CE)) from the DU to a UE. The “handover” command in L1/L2 mobility can be about cell activation or deactivation, e.g. activate a new serving PCell while deactivate the old serving PCell.

Currently, issues of how to handle a TA value during or after TA acquisition in a lower layer-based mobility case have not been solved. Embodiments of the present application aim to solve such issues. For instance, in some embodiments of the present application, after a target DU successfully calculates a TA value, the target DU may transfer it to a source DU via a CU. However, the TA value is not always valid. Once the TA value is invalid, TA acquisition may be triggered again. Some embodiments of the present application aims to design a mechanism of how to determine whether the acquired TA value is invalid or not and how to get or acquire a TA value again after a candidate DU, a CU, a source DU or a UE determines that the acquired TA value for a candidate cell is invalid.

In the embodiments of the present application, TA acquisition or early TA acquisition means that a UE is expected to perform a TA acquisition procedure before a cell switching procedure. TA re-acquisition or early TA re-acquisition means that the UE is expected to perform a TA re-acquisition procedure before a cell switching procedure. TA acquisition, early TA acquisition, TA re-acquisition, or early TA re-acquisition may be triggered by the reception of an indication from the serving BS, e.g. a PDCCH order which is DCI.

Some embodiments of the present application may be applicable for a case of “lower layer triggered mobility” or “L1/L2 triggered mobility”, and the abbreviation of at least one of them may be “LTM”. In an LTM case, a UE may access a serving BS (e.g. a serving gNB). The UE may report Layer3 (L3) measurement result(s) based on the configuration from the serving gNB. If the serving gNB, e.g. a CU of the serving gNB, decides to switch the UE to a candidate cell based on the measurement result(s), the serving gNB may request target DU(s) to prepare the configuration for one or more candidate cells. After receiving the candidate cell configuration from a target DU of the serving gNB, the serving gNB may transmit an RRC reconfiguration message including ID information of one or more candidate cells to the UE. For example, the CU may transmit the RRC reconfiguration message to the UE via a source DU of the serving gNB. The UE may transmit an RRC reconfiguration complete message to the serving gNB (e.g. CU) via the source DU. The UE may ensure UL synchronization or DL synchronization before receiving a cell switch command. For example, the UE may get or acquire a TA value via a random access (RA) or preamble transmission. The UE may report Layer1 (L1) measurement result(s) for a dynamic switching purpose. The serving gNB, e.g. the source DU, may transmit a cell switch command, e.g. a MAC CE or DCI. The UE can apply the RRC reconfiguration message and start a timer upon receiving the lower layer command.

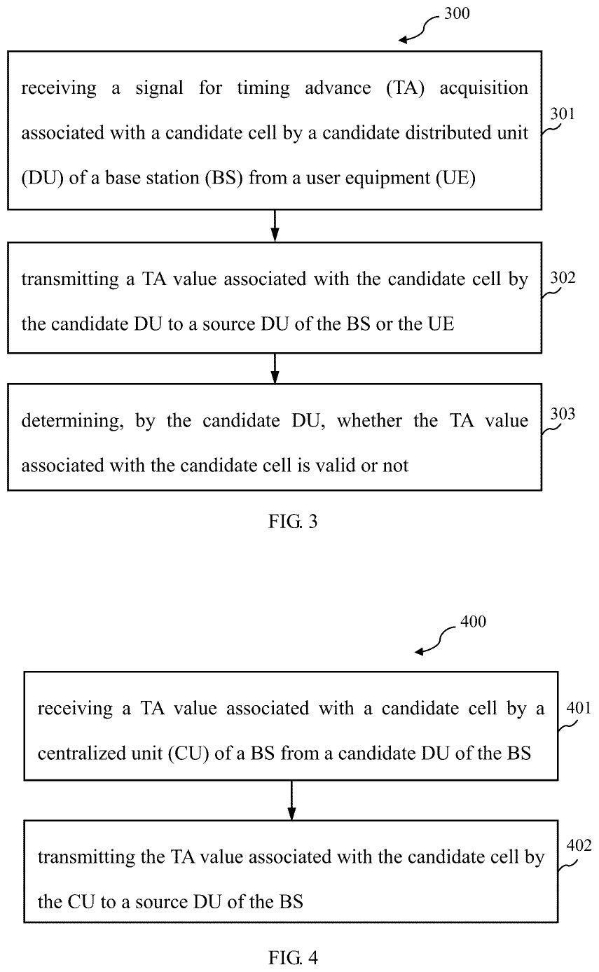

In particular, in embodiments of FIGS. 3-11 of the present application, both inter-DU mobility scenario and intra-DU mobility scenario are considered, e.g. inter-gNB-DU LTM or intra-gNB-DU LTM. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

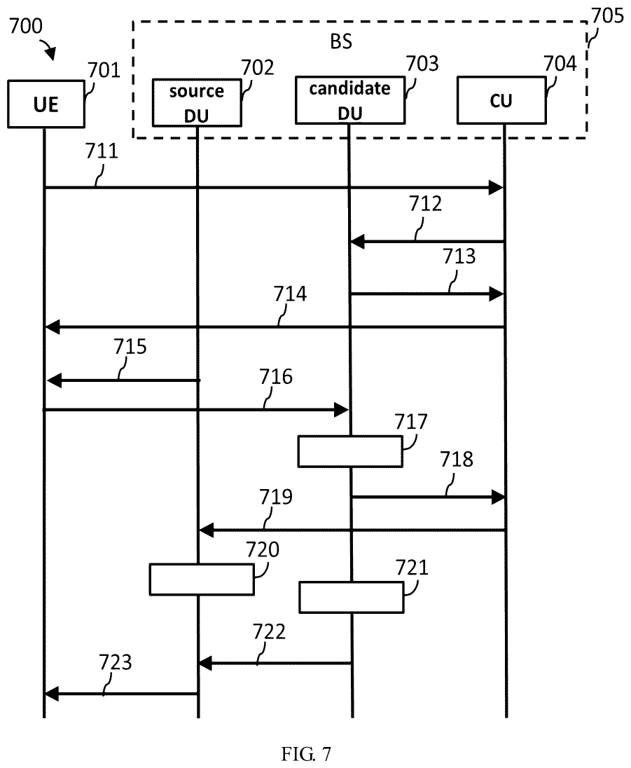

FIG. 3 illustrates an exemplary flowchart associated with TA acquisition in accordance with some embodiments of the present application. The exemplary flowchart 300 in the embodiments of FIG. 3 may be performed by a candidate DU (e.g. DU1 or DU2 or candidate DU 703 as shown and illustrated in FIG. 2 or FIG. 7). A candidate DU may also be named as a target DU in some cases. Although described with respect to a candidate DU, it should be understood that other devices may be configured to perform a flowchart similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-11. A specific example of the embodiments of FIG. 3 is described in the embodiments of FIG. 7 as follows.

In the exemplary flowchart 300, in operation 301, a candidate DU of a BS (e.g. candidate DU 703 as shown and illustrated in FIG. 7) may receive a signal for TA acquisition associated with a candidate cell from a UE (e.g. UE 701 as shown and illustrated in FIG. 7). In some embodiments, the signal is a sequence. For example, the signal is a preamble and/or a sounding reference signal (SRS).

In operation 302, the candidate DU may transmit a TA value associated with the candidate cell to a source DU of the BS (e.g. source DU 702 as shown and illustrated in FIG. 7) or the UE.

In some embodiments, the candidate DU may calculate the TA value associated with the candidate cell based on the signal received in operation 301, and transmit the TA value to the source DU via a CU of the BS (e.g. CU 704 as shown and illustrated in FIG. 7). In some embodiments, the candidate DU may transmit at least one of the following to the source DU via the CU: (1) ID information of the candidate cell; or (2) ID information of the UE.

In some other embodiments, the TA value associated with the candidate cell is transmitted by the candidate DU to the UE in a random access response (RAR) message based on the signal received in operation 301.

In operation 303, the candidate DU may determine whether the TA value associated with the candidate cell is valid or not. In some embodiments, whether the TA value is valid or not is determined based on a condition. The condition based on which the TA value is to be determined as invalid includes at least one of the following:
(1) An expiry of an early TA timer. In some embodiments, the candidate DU may start the early TA timer upon receiving the signal in operation 301 or upon calculating the TA value.
(2) A difference between a RSRP value (denoted as RSRP #1 for simplicity) and another RSRP value (denoted as RSRP #2) is greater than or equal to a threshold related to RSRP change (denoted as threshold #1). In some embodiments, RSRP #1 is a RSRP value when the candidate DU receives the signal in operation 301 or when the candidate DU calculates the TA value, and RSRP #2 is a RSRP value received from the CU or the source DU.

In some embodiments, the candidate DU may receive configuration information regarding the condition from the CU, and the configuration information includes a value for the early TA timer and/or a threshold related to RSRP change (e.g. threshold #1).

In some embodiments, the candidate DU may receive at least one of the following: (1) a Layer 1 (L1) measurement result of the UE from the source DU; or (2) a Layer 3 (L3) measurement result of the UE from the CU. RSRP #2 may be included in the L1 measurement result and/or the L3 measurement result.

In some embodiments, in response to determining that the TA value is invalid, the candidate DU may transmit information for indicating that the TA value is invalid to the source DU via the CU.

In some embodiments, the candidate DU may transmit, to the source DU via the CU, configuration information regarding a RACH resource for TA acquisition associated with the candidate cell.

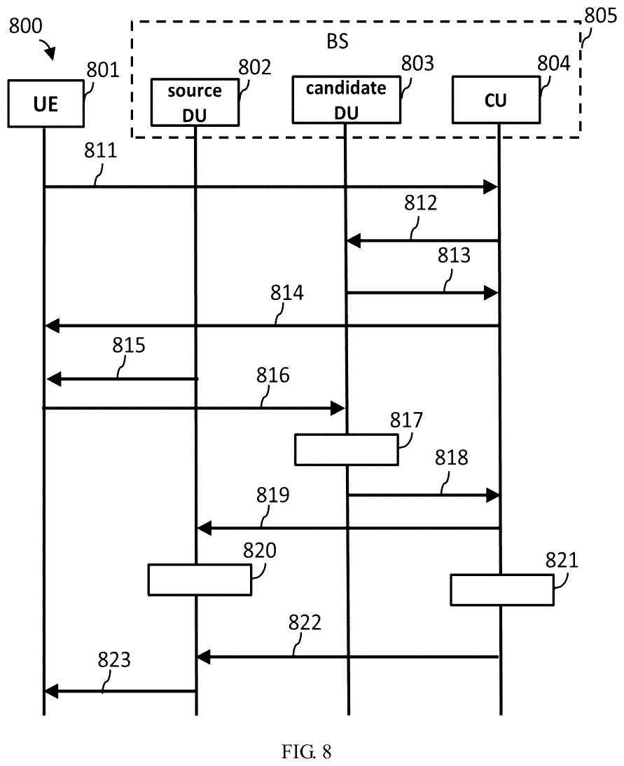

FIG. 4 illustrates a further exemplary flowchart associated with TA acquisition in accordance with some embodiments of the present application. The exemplary flowchart 400 in the embodiments of FIG. 4 may be performed by a CU (e.g. CU or CU 804 as shown and illustrated in FIG. 2 or FIG. 8). Although described with respect to a CU, it should be understood that other devices may be configured to perform a flowchart similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-11. A specific example of the embodiments of FIG. 4 is described in the embodiments of FIG. 8 as follows.

In the exemplary flowchart 400 as shown in FIG. 4, in operation 401, a CU (e.g. CU 804 as shown and illustrated in FIG. 8) may receive a TA value associated with a candidate cell from a candidate DU (e.g. candidate DU 803 as shown and illustrated in FIG. 8) of the BS. In operation 402, the CU may transmit the TA value associated with the candidate cell to a source DU of the BS (e.g. source DU 802 as shown and illustrated in FIG. 8).

In some embodiments, the CU may receive ID information of the candidate cell and ID information of a UE (e.g. UE 801 as shown and illustrated in FIG. 8) from the candidate DU, and transmit the ID information of the candidate cell and the ID information of the UE to the source DU.

In some embodiments, the CU may determine whether the TA value associated with the candidate cell is valid or not. In an embodiment, the CU may determine that the TA value is invalid if a difference between a RSRP value (denoted as RSRP #3 for simplicity) and another RSRP value (denoted as RSRP #4 for simplicity) is greater than or equal to a threshold (e.g. a threshold related to RSRP change, denoted as threshold #2). For instance, RSRP #3 is a RSRP value when the CU receives the TA value, and RSRP #4 is a RSRP value received from the UE via the source DU.

In some embodiments, in response to determining that the TA value is invalid, the CU may transmit “an indication for TA acquisition associated with the candidate cell” to the source DU.

In some embodiments, in response to determining that the TA value is invalid, the CU may transmit “information for indicating that the TA value is invalid” or “a request for a RACH resource for TA acquisition associated with the candidate cell” to the candidate DU.

In some embodiments, the CU may transmit “configuration information regarding a condition associated with determining TA value validity” to the candidate DU and/or the source DU. In an embodiment, the configuration information includes a value of an early TA timer and/or a threshold related to RSRP change (e.g. threshold #2).

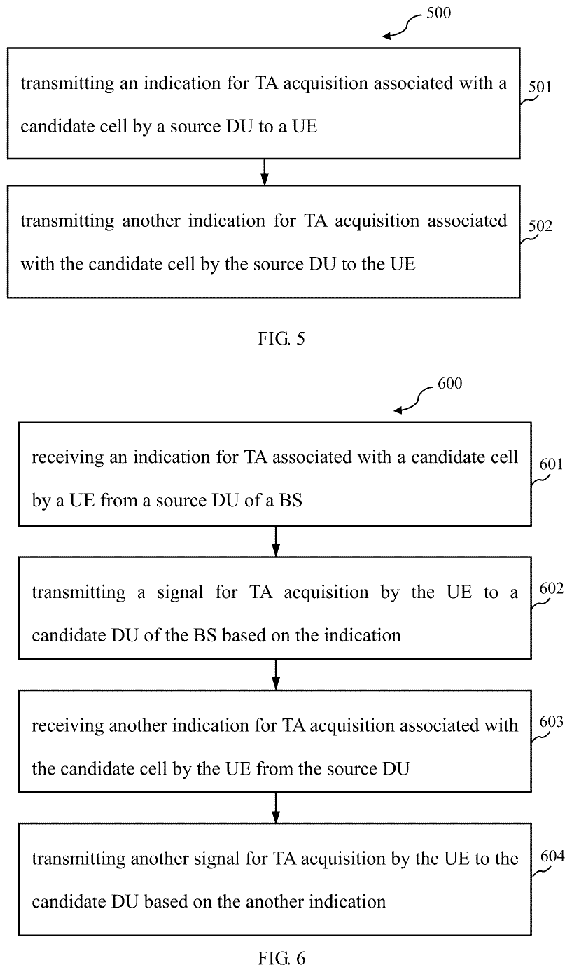

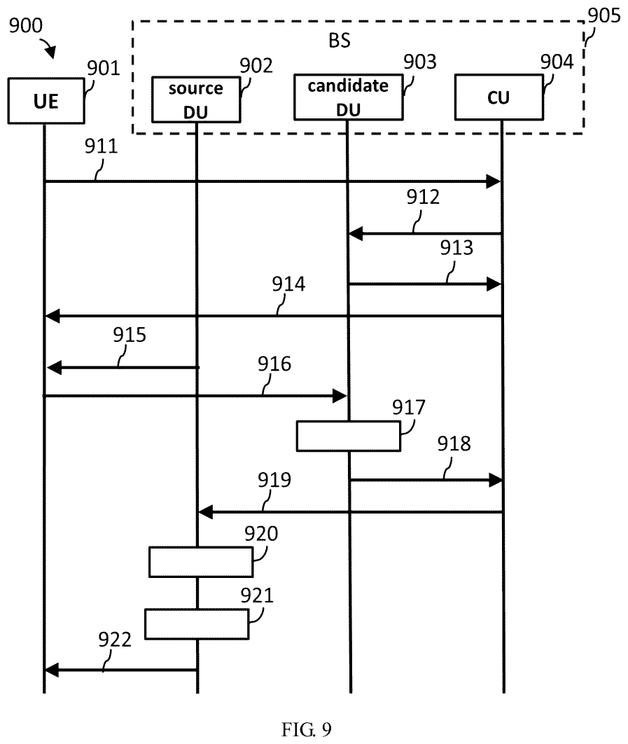

FIG. 5 illustrates another exemplary flowchart associated with TA acquisition in accordance with some embodiments of the present application. The exemplary flowchart 500 in the embodiments of FIG. 5 may be performed by a source DU (e.g. DU2 or DU1 or source DU 902 as shown and illustrated in FIG. 2 or FIG. 9). Although described with respect to a source DU, it should be understood that other devices may be configured to perform a flowchart similar to that of FIG. 5. Details described in all other embodiments of the present application are applicable for the embodiments of FIG. 5. Moreover, details described in the embodiments of FIG. 5 are applicable for all the embodiments of FIGS. 1-4 and 6-11. A specific example of the embodiments of FIG. 5 is described in the embodiments of FIG. 9 as follows.

In the exemplary flowchart 500 as shown in FIG. 5, in operation 501, a source DU (e.g. source DU 902 as shown and illustrated in FIG. 9) may transmit an indication (denoted as indication #1 for simplicity) for TA acquisition associated with a candidate cell to a UE (e.g. UE 901 as shown and illustrated in FIG. 9).

In operation 502, the source DU may transmit another indication (denoted as indication #2) for TA acquisition associated with the candidate cell to the UE.

In some embodiments, indication #1 and/or indication #2 may be included in at least one of the following: DCI; a MAC CE; or RRC signaling.

In some embodiments, after transmitting indication #1, the source DU may receive at least one of the following from the CU: (1) a TA value associated with the candidate cell; (2) ID information of the candidate cell; ID information of the UE; or (3) configuration information regarding a condition used to determine whether the TA value associated with the candidate cell is valid or not.

In some embodiments, the condition based on which the TA value is to be determined as invalid includes at least one of the following: (1) an expiry of an early TA timer; or (2) a difference between a RSRP value (denoted as RSRP #5) and another RSRP value (denoted as RSRP #6) is greater than or equal to a threshold related to RSRP change (denoted as threshold #3).

In some embodiments, the configuration information regarding the condition includes a value of the early TA timer and/or a threshold related to RSRP change (e.g. threshold #3).

In some embodiments, RSRP #5 is a RSRP value when the source DU transmits indication #1 or when the source DU receives the TA value, and RSRP #6 is a RSRP value received from the UE.

In some embodiments, the source DU may receive a Layer 1 (L1) measurement result of the UE from the UE, wherein RSRP #6 is included in the L1 measurement result.

In some embodiments, the source DU may determine whether the TA value associated with the candidate cell is valid or not based on the condition.

In some embodiments, indication #2 is transmitted in response to determining that the TA value is invalid.

In some embodiments, after transmitting indication #2, the source DU may release configuration information regarding a RACH resource or a SRS resource for acquiring the TA value. In the embodiment, the RACH resource includes a preamble and/or a time-frequency domain resource.

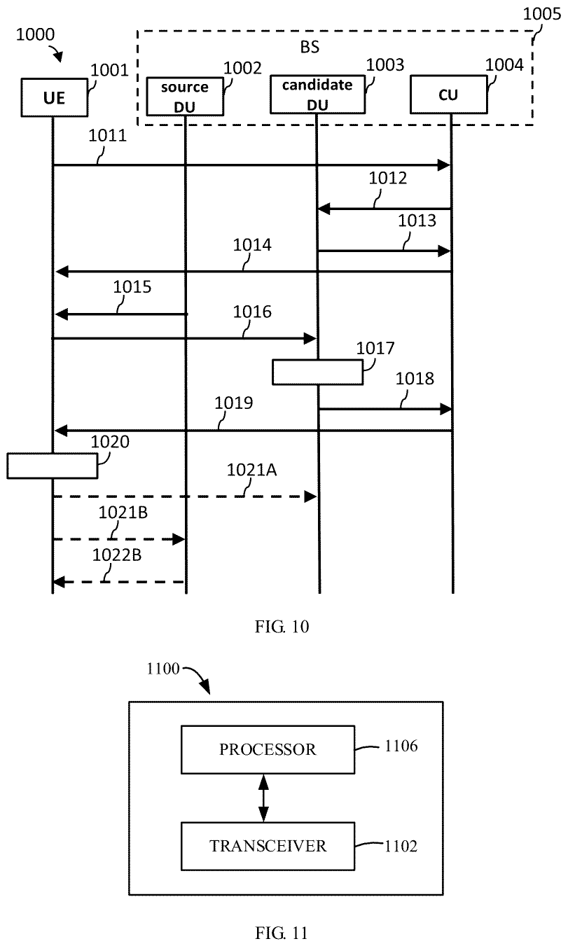

FIG. 6 illustrates yet another exemplary flowchart associated with TA acquisition in accordance with some embodiments of the present application. The exemplary flowchart 600 in the embodiments of FIG. 6 may be performed by a UE (e.g. UE 102 or UE 1001 as shown and illustrated in FIG. 1 or FIG. 10). Although described with respect to a UE, it should be understood that other devices may be configured to perform a flowchart similar to that of FIG. 6. Details described in all other embodiments of the present application are applicable for the embodiments of FIG. 6. Moreover, details described in the embodiments of FIG. 6 are applicable for all the embodiments of FIGS. 1-5 and 7-11. A specific example of the embodiments of FIG. 6 is described in the embodiments of FIG. 10 as follows.

In the exemplary flowchart 600 as shown in FIG. 6, in operation 601, a UE (UE 1001 as shown and illustrated in FIG. 10) may receive an indication (denoted as indication #3 for simplicity) for TA associated with a candidate cell from a source DU of a BS (e.g. source DU 1002 as shown and illustrated in FIG. 10). In operation 602, the UE may transmit a signal (denoted as signal #1) for TA acquisition to a candidate DU of the BS (e.g. candidate DU 1003 as shown and illustrated in FIG. 10) based on indication #3.

In operation 603, the UE may receive another indication (denoted as indication #4) for TA acquisition associated with the candidate cell from the source DU. In operation 604, the UE may transmit another signal (denoted as signal #2) for TA acquisition to the candidate DU based on indication #4.

In some embodiments, indication #3 and/or indication #4 is included in at least one of the following: DCI; a MAC CE; or RRC signaling.

In some embodiments, signal #and/or signal #2 is a sequence, e.g., a preamble and/or a SRS.

In some embodiments, the UE may receive a TA value associated with the candidate cell from the candidate DU after transmitting signal #1; and determine whether the TA value associated with the candidate cell is valid or not.

In some embodiments, the TA value is included in: a cell switch command (e.g. a MAC CE command); or a RAR message prior to the cell switch command.

In some embodiments, the UE may determine that the TA value is invalid based on a condition, and the condition includes at least one of the following: (1) an expiry of an early TA timer; or (2) a difference between a RSRP value (denoted as RSRP #7) and another RSRP value (denoted as RSRP #8) is greater than or equal to a threshold related to RSRP change (denoted as threshold #4).

In some embodiments, the UE may receive configuration information regarding the condition from the CU, and the configuration information is configured by the CU or the candidate DU. In an embodiment, the configuration information includes at least one of the following: (1) a value of the early TA timer; or (2) a threshold related to RSRP change (e.g. threshold #4).

In some embodiments, the UE may start the early TA timer upon the UE receives indication #3 or when the UE receives the TA value.

In some embodiments, RSRP #7 is a RSRP value when the UE transmits signal #1, and RSRP #8 is a RSRP value measured by the UE after the UE receives the TA value.

In some embodiments, signal #2 is transmitted in response to determining that the TA value is invalid.

In some embodiments, in response to determining that the TA value is invalid, the UE may transmit information for indicating that the TA value is invalid to the source DU.

The following text describes specific embodiments of the flowchart as shown and illustrated in any of FIGS. 3-6. It should be appreciated by persons skilled in the art that the sequence of the operations in any of exemplary flowcharts 700, 800, 900, and 1000 in FIGS. 7-10 may be changed and some of the operations in any of exemplary flowcharts 700, 800, 900, and 1000 in FIGS. 7-10 may be eliminated or modified, without departing from the spirit and scope of the disclosure.

FIG. 7 illustrates an exemplary flowchart of TA acquisition in accordance with some embodiments of the present application. The embodiments of FIG. 7 refer to a candidate cell triggered TA re-acquisition scenario, in which a candidate DU determines whether a TA value is valid or not. Details described in all other embodiments of the present application are applicable for the embodiments shown in FIG. 7.

As shown in FIG. 7, BS 705 is in CU-DU architecture, and includes CU 704, source DU 702, and candidate DU 703. In the embodiments of FIG. 7, a cell switching operation performed by UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell switching operation in an Inter-DU case for the exemplary purpose. The flowchart 700 also can be applied to an intra-DU case if source DU 702 and candidate DU 703 are the same DU.

In the exemplary flowchart 700 as shown in FIG. 7, in operation 711, UE 701 may access the serving BS (e.g. gNB) and send a measurement report to the serving BS, for example, BS 705. The serving BS may include a CU (e.g. gNB-CU) and one or more DUs (e.g. gNB-DUs). A serving cell is associated with a CU and a DU. There is an F1 interface between the DU and the CU. For example, as shown in FIG. 7, BS 705 includes CU 704, source DU 702, and candidate DU 703. BS 705 may include one or more other candidate DUs (not shown in FIG. 7).

In operation 712, CU 704 may determine to initiate L1/L2 based inter-cell mobility configuration and transmit a request message, e.g. a UE CONTEXT SETUP REQUEST message to one or more candidate DUs (e.g. candidate DU 703) which are associated with one or more candidate cells. In some embodiments, the condition for determining a TA value from CU 704 may be sent to candidate DU 703. The condition could be a value of the early TA timer or a threshold related to RSRP change (e.g. threshold #1 as described in the embodiments of FIG. 3).

In operation 713, if candidate DU 703 decides to accept the request of LTM configuration, candidate DU 703 may generate lower layer RRC configuration for the accepted one or more candidate cell(s) and send a response message to CU 704 including the generated lower layer RRC configuration. The response message could be a UE CONTEXT SETUP RESPONSE message.

In operation 714, CU 704 may generate an RRCReconfiguration message based on the configuration for the accepted candidate cell(s) received from candidate DU 703 and transmit the RRCReconfiguration message associated with the candidate cell(s) for LTM configuration to UE 701 via source DU 702.

In operation 715, UE 701 may receive information to trigger TA acquisition to a candidate cell within the candidate cell(s) from source DU 702. In some embodiments, the information could be DCI, a MAC CE or RRC signaling. If the information is DCI, it could be a PDCCH order.

In some embodiments, after source DU 702 transmits the information to trigger TA acquisition (e.g., a PDCCH order) associated with the candidate cell to UE 701, source DU 702 may release the dedicated RACH configuration for TA acquisition, e.g. a dedicated preamble and/or a dedicated time-frequency domain resource. In some other embodiments, source DU 702 may keep the dedicated RACH resource for TA acquisition.

In operation 716, UE 701 may transmit a signal (e.g. a sequence, for example, a dedicated preamble or a SRS) for TA acquisition to candidate DU 703.

In operation 717, after candidate DU 703 successfully receives the signal for TA acquisition, candidate DU 703 may calculate or generate a TA value associated with the candidate cell.

In operation 718, candidate DU 703 may transmit a message, which includes the calculated TA value, ID information of the corresponding candidate cell, and/or ID information of UE 701, to CU 704 via F1 interface. The F1 message may be an UL RRC MESSAGE TRANSFER message or a UE Context Modification Request message.

In operation 719, after CU 704 receives the TA value, CU 704 transmits the received TA value to source DU 702. In some embodiments, CU 704 will transmit the TA value, ID information of the corresponding candidate cell, and/or ID information of UE 701 to source DU 702 via F1 interface.

In operation 720, after source DU 702 receives the TA value, source DU 702 stores the TA value, ID information of the corresponding candidate cell, and/or ID information of UE 701. In some embodiments, if source DU 702 receives the TA value for the same candidate cell and UE 701, source DU 702 stores the latest TA value.

In operation 721, candidate DU 703 determines whether the current TA value associated with the candidate cell is invalid or not. In some embodiments, candidate DU 703 may determine whether the TA value associated with the candidate cell is valid or not until determining that the TA value is invalid, e.g. based on condition(s).

In an embodiment, RSRP #1 is a RSRP value when candidate DU 703 receives a preamble (or a SRS) in operation 716 or when candidate DU 703 calculate or generates the TA value in operation 717. RSRP #2 is a RSRP value received from CU 704 or source DU 702. In an embodiment, source DU 702 may receive the measurement report, e.g. L1 measurement result(s), which will be transferred to candidate DU 703 via CU 704. In addition, CU 704 may transfer L3 measurement result(s) to candidate DU 703. RSRP #2 may be included in the L1 measurement result(s) and/or L3 measurement result(s). For example, if the RSRP change (RSRP #2-RSRP #1) is equal to or greater than or equal to a threshold (e.g. threshold #1), the TA value is considered as invalid. Once RSRP change (RSRP #2-RSRP #1) is greater than or equal to the threshold, candidate DU 703 determines that the TA value is invalid.

In another embodiment, a timer (e.g., an early TA timer) is used for determine whether the TA value is invalid or not. Candidate DU 703 may start the timer when receiving the signal (e.g. a preamble or a SRS) for TA acquisition in operation 716 or calculating the TA value in operation 717. The value of the timer may be configured by CU 704. If the timer expires, the TA value is considered as invalid. Once the timer expires, candidate DU 703 determines that the TA value is invalid.

In operation 722, if candidate DU 703 determines that the current TA value is invalid based on the L1 or L3 measurement result(s), candidate DU 703 will indicate to source DU 702 via CU 704. For instance, candidate DU 703 transmits an indication for indicating that current TA value is invalid. The new RACH resource may be transmitted to source DU 702 as well.

In operation 723, source DU 702 may transmit information to trigger TA acquisition (e.g. a PDCCH order) associated with the candidate cell to UE 701 again to acquire the latest TA value for the candidate cell.

FIG. 8 illustrates a further exemplary flowchart of TA acquisition in accordance with some embodiments of the present application. The embodiments of FIG. 8 refer to a CU triggered TA re-acquisition scenario, in which a CU determines whether a TA value is valid or not. Details described in all other embodiments of the present application are applicable for the embodiments shown in FIG. 8.

As shown in FIG. 8, BS 805 is in CU-DU architecture, and includes CU 804, source DU 802, and candidate DU 803. In the embodiments of FIG. 8, a cell switching operation performed by UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell switching operation in an Inter-DU case for the exemplary purpose. The flowchart 800 also can be applied to an intra-DU case if source DU 802 and candidate DU 803 are the same DU.

In the exemplary flowchart 800 as shown in FIG. 8, in operation 811, UE 801 may access the serving BS (e.g. gNB) and send a measurement report to the serving BS, for example, BS 805. The serving BS may include a CU (e.g. gNB-CU) and one or more DUs (e.g. gNB-DUs). A serving cell is associated with a CU and a DU. There is an F1 interface between the DU and CU. For example, as shown in FIG. 8, BS 805 includes CU 804, source DU 802, and candidate DU 803. BS 805 may include one or more other candidate DUs (not shown in FIG. 8).

In operation 812, CU 804 may determine to initiate L1/L2 based inter-cell mobility configuration and transmit a request message, e.g. a UE CONTEXT SETUP REQUEST message to one or more candidate DUs (e.g. candidate DU 803), which are associated with one or more candidate cells.

In operation 813, if candidate DU 803 decides to accept the request of LTM configuration, candidate DU 803 may generate lower layer RRC configuration for the accepted one or more candidate cell(s) and send a response message to CU 804 including the generated lower layer RRC configuration. The response message could be a UE CONTEXT SETUP RESPONSE message.

In operation 814, CU 804 may generate an RRCReconfiguration message based on the configuration for the accepted candidate cell(s) from candidate DU 803 and transmit the RRCReconfiguration message associated with the candidate cell(s) for LTM configuration to UE 801 via source DU 802.

In operation 815, UE 801 receives information for triggering TA acquisition to a candidate cell within the candidate cell(s). In some embodiments, the information could be DCI, a MAC CE or RRC signaling. If the information is DCI, it could be a PDCCH order.

In some embodiments, after source DU 802 transmits the information to trigger TA acquisition (e.g., a PDCCH order) associated with the candidate cell to UE 801, source DU 802 may release or store the dedicated RACH resource (e.g. a dedicated preamble, and/or a dedicated time-frequency domain resource) or the dedicated SRS resource for TA acquisition.

In operation 816, UE 801 may transmit a signal (e.g. a sequence, for example, a dedicated preamble or a SRS) for TA acquisition to candidate DU 803.

In operation 817, after candidate DU 803 successfully receives the signal for TA acquisition, candidate DU 803 may calculate or generate a TA value associated with the candidate cell.

In operation 818, candidate DU 803 may transmit a message, which includes the calculated TA value, ID information of the corresponding candidate cell, and/or ID information of UE 801, to CU 804 via F1 interface. The F1 message can be an UL RRC MESSAGE TRANSFER message or a UE Context Modification Request message.

In operation 819, after CU 804 receives the TA value, CU 804 transmits the received TA value to source DU 802. In some embodiments, CU 804 will transmit the TA value, ID information of the corresponding candidate cell, and/or ID information of UE 801 to source DU 802 via F1 interface.

In operation 820, after source DU 802 receives the TA value, source DU 802 stores the TA value, ID information of the corresponding candidate cell, and/or ID information of UE 801.

In operation 821, CU 804 determines whether the current TA value associated with the candidate cell is valid or not. In some embodiments, CU 804 may determine whether the TA value associated with the candidate cell is valid or not until determining that the TA value is invalid, e.g. based on condition(s).

In some embodiments, CU 804 may determine whether the current TA value is valid or not based on L3 measurement result(s). In an embodiment, CU 804 determines whether a RSRP change is greater than or equal to a threshold related to RSRP change. For example, For instance, RSRP #3 is a RSRP value when CU 804 receives the TA value, and RSRP #4 is a RSRP value is included in L3 measurement result(s) received by CU 804 from UE 801 via source DU 802. If the RSRP change (RSRP #4-RSRP #3) is equal to or greater than or equal to a threshold (e.g. threshold #2 as described in the embodiment of FIG. 4), the TA value is considered as invalid. Once RSRP change (RSRP #4-RSRP #3) is greater than or equal to the threshold, CU 804 determines that the TA value is invalid.

In operation 822, once CU determines the TA is invalid, CU 804 transmits an indication of TA re-acquisition to source DU 802. Before CU 804 transmits the indication to source DU 802, CU 804 may request the latest RACH resource from candidate DU 803.

In operation 823, source DU 802 may transmit information to trigger TA acquisition (e.g. a PDCCH order) associated with the candidate cell to UE 801 again to acquire the latest TA value for the candidate cell.

FIG. 9 illustrates another exemplary flowchart of TA acquisition in accordance with some embodiments of the present application. The embodiments of FIG. 9 refer to a source DU triggered TA re-acquisition scenario, in which a source DU determines whether a TA value is valid or not. Details described in all other embodiments of the present application are applicable for the embodiments shown in FIG. 9.

As shown in FIG. 9, BS 905 is in CU-DU architecture, and includes CU 904, source DU 902, and candidate DU 903. In the embodiments of FIG. 9, a cell change of UE 901 may refer to an Intra-DU case in which a source cell and a target cell in the same DU or refer to an Inter-DU case in which a source cell and a target cell are located at different DUs. For instance, the flowchart 900 as shown in FIG. 9 only shows a cell change in an Inter-DU case for the exemplary purpose. The flowchart 900 can be applied to an intra-DU case if source DU 902 and candidate DU 903 are the same DU.

In the exemplary flowchart 900 as shown in FIG. 9, in operation 911, UE 901 may access the serving BS (e.g. gNB) and send a measurement report to the serving BS, for example, BS 905. The serving BS may include a CU (e.g. gNB-CU) and one or more DUs (e.g. gNB-DUs). A serving cell is associated with a CU and a DU. There is F1 interface between the DU and the CU. For example, as shown in FIG. 9, BS 905 includes CU 904, source DU 902, and candidate DU 903. BS 905 may include one or more other candidate DUs (not shown in FIG. 9).

In operation 912, CU 904 may determine to initiate L1/L2 based inter-cell mobility configuration and transmit a request message, e.g. a UE CONTEXT SETUP REQUEST message to one or more candidate DUs (e.g. candidate DU 903), which are associated with one or more candidate cells.

In operation 913, if candidate DU 903 decides to accept the request of LTM configuration, candidate DU 903 may generate lower layer RRC configuration for the accepted one or more candidate cell(s) and send a response message to CU 804 including the generated lower layer RRC configuration. The response message could be with a UE CONTEXT SETUP RESPONSE message.

In operation 914, CU 904 will generate an RRCReconfiguration message based on the configuration for the accepted candidate cell(s) from candidate DU 903 and transmit the RRCReconfiguration message associated with the candidate cell(s) for LTM configuration to UE 901 via source DU 902.

In operation 915, UE 901 may receive information (e.g. indication #1 as described in the embodiment of FIG. 5) for triggering TA acquisition to a candidate cell within the candidate cell(s) from source DU 902. In some embodiments, the information could be DCI, a MAC CE or RRC signaling. If the information is DCI, it could be a PDCCH order.

In some embodiments, after source DU 902 transmits the information to trigger TA acquisition (e.g., a PDCCH order) associated with the candidate cell to UE 901, source DU 902 may release or store the dedicated RACH resource (e.g. a dedicated preamble, and/or a dedicated time-frequency domain resource) or the dedicated SRS resource for TA acquisition.

In operation 916, UE 901 may transmit a signal (e.g. a sequence, for example, a dedicated preamble or a SRS) for TA acquisition to candidate DU 903.

In operation 917, after candidate DU 903 successfully receives the signal for TA acquisition, candidate DU 903 will calculate or generate a TA value associated with the candidate cell.

In operation 918, candidate DU 903 transmits a message, which includes the calculated TA value, ID information of the corresponding candidate cell, and/or ID information of UE 901, to CU 904 via F1 interface. The F1 message can be a UL RRC MESSAGE TRANSFER message or a UE Context Modification Request message.

In operation 919, after CU 904 receives the TA value, CU 904 transmits the received TA value to source DU 902. In some embodiments, CU 904 may transmit the TA value, ID information of the corresponding candidate cell, and/or ID information of UE 901 to source DU 902 via F1 interface.

In operation 920, after source DU 902 receives the TA value, source DU 902 stores the TA value, ID information of the corresponding candidate cell, and/or ID information of UE 901.

In operation 921, source DU 902 determines whether the current TA value associated with the candidate cell is valid or not. In some embodiments, source DU 902 may determine whether the TA value associated with the candidate cell is valid or not until determining that the TA value is invalid, e.g. based on condition(s).

In some embodiments, source DU 902 may maintain configuration information regarding condition(s) for determining whether a TA value is valid or not. The configuration information may include a value of the early TA timer and/or a threshold related to RSRP change. The configuration information could be provided by CU 904 or candidate DU 903 to source DU 902.

In an embodiment, regarding RSRP change, RSRP #5 may be a RSRP when source DU 902 transmits the information to trigger TA acquisition (e.g., a PDCCH order) in operation 915, or a RSRP when source DU 902 receives the TA value from candidate DU 903. RSRP #6 is a RSRP value received from UE 901. In an embodiment, source DU 902 may receive a Layer 1 (L1) measurement result of UE 901 from UE 901, wherein RSRP #6 is included in the L1 measurement result. For example, if the RSRP change (RSRP #6-RSRP #5) is equal to or greater than or equal to a threshold (e.g. threshold #3 as described in the embodiments of FIG. 5), the TA value is considered as invalid. Once RSRP change (RSRP #6-RSRP #5) is greater than or equal to the threshold, source DU 902 determines that the TA value is invalid.

In another embodiment, a timer (e.g., an early TA timer) is used for determine whether the TA value is invalid or not. Source DU 902 may start the timer when source DU 902 transmits the information to trigger TA acquisition (e.g., a PDCCH order) associated with the candidate cell in operation 915. The value of the timer may be configured by CU 904. If the timer expires, the TA value is considered as invalid. Once the timer expires, source DU 902 determines that the TA value is invalid.

In operation 922, once source DU 902 determines that the TA value for the candidate cell is invalid, source DU 902 transmits information (e.g. indication #2 as described in the embodiment of FIG. 5) to trigger TA acquisition (e.g. a PDCCH order) associated with the candidate cell to UE 901 again to acquire the latest TA value for the candidate cell. In some embodiments, before source DU 902 transmits the information to trigger TA acquisition to UE 901, source DU 902 may request the latest RACH resource from candidate DU 903.

FIG. 10 illustrates another exemplary flowchart of TA acquisition in accordance with some embodiments of the present application. The embodiments of FIG. 10 refer to a UE triggered TA re-acquisition scenario, in which a UE determines whether a TA value is valid or not. Details described in all other embodiments of the present application are applicable for the embodiments shown in FIG. 10.

As shown in FIG. 10, BS 1005 is in CU-DU architecture, and includes CU 1004, source DU 1002, and candidate DU 1003. In the embodiments of FIG. 10, a cell change of UE 1001 may refer to an Intra-DU case in which a source cell and a target cell in the same DU or refer to an Inter-DU case in which a source cell and a target cell are located at different DUs. For instance, the flowchart 1000 as shown in FIG. 10 only shows a cell change in an Inter-DU case for the exemplary purpose. The flowchart 1000 can be applied to an intra-DU case if source DU 1002 and candidate DU 1003 are the same DU.

In the exemplary flowchart 1000 as shown in FIG. 10, in operation 1011, UE 1001 may access the serving BS (e.g. gNB) and send a measurement report to the serving BS, for example, BS 1005. The serving BS may include a CU (e.g. gNB-CU) and one or more DUs (e.g. gNB-DUs). A serving cell is associated with a CU and a DU. There is F1 interface between the DU and the CU. For example, as shown in FIG. 10, BS 1005 includes CU 1004, source DU 1002, and candidate DU 1003. BS 1005 may include one or more other candidate DUs (not shown in FIG. 10).

In operation 1012, CU 1004 may determine to initiate L1/L2 based inter-cell mobility configuration and transmit a request message, e.g. a UE CONTEXT SETUP REQUEST message to one or more candidate DUs (e.g. candidate DU 1003), which are associated with one or more candidate cells.

In operation 1013, if candidate DU 1003 decides to accept the request of LTM configuration, candidate DU 1003 may generate lower layer RRC configuration for the accepted one or more candidate cell(s) and send a response message to CU 1004 including the generated lower layer RRC configuration. The response message could be with a UE CONTEXT SETUP RESPONSE message.

In operation 1014, CU 1004 may generate an RRCReconfiguration message based on the configuration for the accepted candidate cell(s) from candidate DU 1003 and transmit the RRCReconfiguration message associated with the candidate cell(s) for LTM configuration to UE 1001 via source DU 1002.

In operation 1015, UE 1001 may receive information (e.g. indication #3 as described in the embodiment of FIG. 6) for triggering TA acquisition to a candidate cell within the candidate cell(s). In some embodiments, the information could be DCI, a MAC CE or RRC signaling. If the information is DCI, it could be a PDCCH order.

In some embodiments, after source DU 1002 transmits the information to trigger TA acquisition (e.g., a PDCCH order) associated with the candidate cell to UE 1001, source DU 1002 may release or store the dedicated RACH resource (e.g. a dedicated preamble, and/or a dedicated time-frequency domain resource) or the dedicated SRS resource for TA acquisition.

In operation 1016, UE 1001 may transmit a signal (e.g. a sequence, for example, a dedicated preamble or a SRS) for TA acquisition (e.g. signal #1 as described in the embodiments of FIG. 6) to candidate DU 1003.

In operation 1017, after candidate DU 1003 successfully receives signal for TA acquisition, candidate DU 1003 may calculate or generate a TA value associated with the candidate cell.

In operation 1018, the candidate DU 1003 may transmit a message, which includes the calculated TA value, ID information of the corresponding candidate cell, and/or ID information of UE 801, to CU 1004 via F1 interface. The F1 message can be a UL RRC MESSAGE TRANSFER message or a UE Context Modification Request message.

In operation 1019, there may be following two cases in different embodiments, i.e., Case 1 and Case 2 as below.
(1) Case 1: In operation 1019, UE 1001 may receive the TA value which is included in a cell switch command (e.g. a MAC CE command). In Case 1, UE 1001 does not receive a RAR message. UE 1001 is not expected to keep the TA value before cell switching.
(2) Case 2: In operation 1019, UE 1001 will receive a RAR message including the TA value before cell switching. In Case 2, UE 1001 needs to keep the TA value before cell switching.

In operation 1020, UE 1001 may determine whether the current TA value associated with the candidate cell is valid or not. In some embodiments, UE 1001 may determine whether the TA value associated with the candidate cell is valid or not until determining that the TA value is invalid, e.g. based on condition(s).

In some embodiments, UE 1001 may maintain configuration information regarding condition(s) for determining whether a TA value is valid or not. The configuration information may include a value of the early TA timer and/or a threshold related to RSRP change. The configuration information could be provided by CU 1004 or candidate DU 1003.

In an embodiment, in operation 1020, UE 1001 starts a timer (e.g., an early TA timer) once UE 1001 receiving the information to trigger TA acquisition (e.g., a PDCCH order) in operation 1015 or the TA value in operation 1019. The value of the timer may be configured by CU 904. If the timer expires, the TA value is considered as invalid. Once the timer expires, UE 1001 determines that the TA value is invalid.

In another embodiment, regarding RSRP change, RSRP #7 may be a RSRP when UE 1001 transmits the signal (e.g. a dedicated preamble or a SRS) for TA acquisition in operation 1016. RSRP #8 is a RSRP value measured by the UE after the UE receives the TA value. For example, if the RSRP change (RSRP #8-RSRP #7) is equal to or greater than or equal to a threshold (e.g. threshold #4 as described in the embodiments of FIG. 6), the TA value is considered as invalid. Once RSRP change (RSRP #8-RSRP #7) is greater than or equal to the threshold, UE 1001 determines that the TA value is invalid.

After UE 1001 determines that the TA value is invalid, there may be following two options in different embodiments, i.e., Option 1 and Option 2 as below.
(1) Option 1: After UE 1001 receives the information to trigger TA acquisition (e.g., a PDCCH order) in operation 1015, UE 1001 transmits the signal (e.g. a dedicated preamble or a SRS) for TA acquisition (e.g. signal #1) to candidate DU 1003 in operation 1016. In operation 1021A (optional), once UE 1001 determines that the TA value for the candidate cell is invalid, UE 1001 is triggered to transmit the signal (e.g. a dedicated preamble or a SRS) for TA acquisition (e.g. signal #2 as described in the embodiments of FIG. 6) to candidate DU 1003 again.
(2) Option 2: In operation 1021B (optional), once UE 1001 determines that the TA value for the candidate cell is invalid, UE 1001 transmits information for indicating that the TA value is invalid to the network, e.g. source DU1002. In operation 1022B (optional), source DU 1002 may transmit information (e.g. indication #4 as described in the embodiment of FIG. 6) to trigger TA acquisition (e.g., a PDCCH order) associated with the candidate cell again to UE 1001. In operation 1022B, there may be following two options in different embodiments, i.e., Option A and Option B as below.
   a) Option A: In Inter-DU case, once source DU 1002 receives the information for indicating that the TA value is invalid from UE 1001, source DU 1002 transmits information for indicating that the TA value is invalid to candidate DU 1003 via CU 1004. Then, candidate DU 1003 transmits a RACH resource (e.g. a dedicated preamble or dedicated time-frequency resource) to source DU 1002 via CU 1004. Finally, source DU 1002 transmits the information (e.g. indication #4, for example, a PDCCH order) to UE 1001 to trigger TA re-acquisition.
   b) Option B: In Intra-DU case, once source DU 1002 receives the information for indicating that the TA value is invalid from UE 1001, source DU 1002 transmits the information (e.g. indication #4, for example, a PDCCH order) to UE 1001 to trigger TA acquisition based on a RACH resource.

FIG. 11 illustrates a block diagram of an exemplary apparatus 1100 in accordance with some embodiments of the present application. As shown in FIG. 11, the apparatus 1100 may include at least one processor 1106 and at least one transceiver 1102 coupled to the processor 1106. Although in this figure, elements such as the at least one transceiver 1102 and processor 1106 are described in the singular, the plural is contemplated unless a limitation to the singular is explicitly stated. In some embodiments of the subject application, the transceiver 1102 may be divided into two devices, such as a receiving circuitry and a transmitting circuitry. In some embodiments of the subject application, the apparatus 1100 may further include an input device, a memory, and/or other components.

In some embodiments of the subject application, the apparatus 1100 may be a UE or a network node (e.g. a BS, a CU, or a DU). The transceiver 1102 and the processor 1106 may interact with each other so as to perform the operations with respect to the UE or the network node described above, for example, in any of FIGS. 1-10.

In some embodiments of the subject application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to a UE or a network node (e.g. a BS, a CU, or a DU) as described above. For example, the computer-executable instructions, when executed, cause the processor 1106 interacting with transceiver 1102 to perform the operations with respect to the UE or the network node described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A candidate distributed unit (DU) of a base station (BS), comprising:
at least one memory; and
at least one processor coupled with the at least one memory and configured to cause the candidate DU to:
receive a signal for timing advance (TA) acquisition associated with a candidate cell from a user equipment (UE);
transmit a TA value associated with the candidate cell to a source DU of the BS or the UE; and
determine whether the TA value associated with the candidate cell is valid.

2. The candidate DU of claim 1, wherein the signal is at least one of:
a preamble; or
a sounding reference signal (SRS).

3. The candidate DU of claim 1, wherein the at least one processor is further configured to cause the candidate DU to calculate the TA value based on the received signal, and wherein the TA value is transmitted to the source DU via a centralized unit (CU) of the BS.

4. The candidate DU of claim 3, wherein the at least one processor is further configured to cause the candidate DU to transmit at least one of the following to the source DU via the CU:
identifier (ID) information of the candidate cell; or
ID information of the UE.

5. The candidate DU of claim 1, wherein the TA value is transmitted to the UE in a random access response (RAR) message based on the received signal.

6. The candidate DU of claim 1, wherein the TA value is valid on a condition, and wherein the condition based on the TA value being invalid includes at least one of the following:
an expiry of an early TA timer; or
a difference between a first reference signal received power (RSRP) value and a second RSRP value is greater than or equal to a threshold related to RSRP change.

7. The candidate DU of claim 6, wherein the at least one processor is further configured to cause the candidate DU to receive configuration information regarding the condition the CU, and wherein the configuration information includes at least one of the following:
a value for the early TA timer; or
the threshold related to RSRP change.

8. The candidate DU of claim 6, wherein the at least one processor is further configured to cause the candidate DU to start the early TA timer upon receiving the signal or upon calculating the TA value.

9. The candidate DU of claim 6, wherein the first RSRP value is a RSRP value when the candidate DU receives the signal or when the candidate DU calculates the TA value, and wherein the second RSRP value is a RSRP value received from the CU or the source DU.

10. The candidate DU of claim 1, wherein the at least one processor is further configured to cause the candidate DU to receive at least one of the following:
a Layer 1 (L1) measurement result of the UE from the source DU; or
a Layer 3 (L3) measurement result of the UE from the CU,
wherein the second RSRP value is included in at least one of the L1 measurement result or the L3 measurement result.

11. The candidate DU of claim 1, wherein, in response to determining that the TA value is invalid, the at least one processor is further configured to transmit information indicating that the TA value is invalid to the source DU via the CU.

12. The candidate DU of claim 11, wherein the at least one processor is further configured to transmit, to the source DU via the CU, configuration information regarding a random access channel (RACH) resource for TA acquisition associated with the candidate cell.

13. A centralized unit (CU) of a base station (BS), comprising:
at least one memory; and
at least one processor coupled with the at least one memory and configured to cause the CU to:
receive a timing advance (TA) value associated with a candidate cell from a candidate distributed unit (DU) of the BS; and
transmit the TA value associated with the candidate cell to a source DU of the BS.

14. A source distributed unit (DU) of a base station (BS), comprising:
at least one memory; and
at least one processor coupled with the at least one memory and configured to cause the source DU to:
transmit a first indication for timing advance (TA) acquisition associated with a candidate cell to a user equipment (UE); and
transmit a second indication for TA acquisition associated with the candidate cell to the UE.

15. (canceled)

16. The source DU of claim 14, wherein at least one of the first indication or the second indication is included by:
downlink control information (DCI);
a medium access control (MAC) control element (CE); or
radio resource control (RRC) signaling.

17. The source DU of claim 14, wherein, after transmitting the first indication, the at least one processor is further configured to cause the source DU to receive from the CU:
a first TA value associated with the candidate cell;
identifier (ID) information of the candidate cell;
ID information of the UE; or
configuration information regarding a condition used to determine whether the first TA value associated with the candidate cell is valid.

18. The source DU of claim 17, wherein the condition includes:
an expiry of an early TA timer; or
a difference between a first reference signal received power (RSRP) value and a second RSRP value is greater than or equal to a threshold related to an RSRP change.

19. The source DU of claim 18, wherein the configuration information regarding the condition includes:
a value of the early TA timer; or
the threshold related to the RSRP change.

20. The source DU of claim 18, wherein the first RSRP value is an RSRP value when the source DU transmits the first indication or when the source DU receives the first TA value, and the second RSRP value is an RSRP value received from the UE.

21. A user equipment (UE) for wireless communication, comprising:
at least one memory; and
at least one processor coupled with the at least one memory and configured to cause the UE to:
receive a first indication for timing advance (TA) associated with a candidate cell from a source distributed unit (DU) of a base station (BS);
transmit a first signal for TA acquisition to a candidate distributed unit (DU) of the BS based on the first indication;
receive a second indication for TA acquisition associated with the candidate cell from the source DU; and
transmit a second signal for TA acquisition to the candidate DU based on the second indication.
